(19) United States
(12) Patent Application Publication
(10) Pub. No.: US 2024/0039696 A1
(43) Pub. Date: Feb. 1, 2024

(54) APPARATUS AND METHOD FOR HOMOMORPHIC ENCRYPTION OF TEXT DATA

(71) Applicant: CRYPTO LAB INC., Seoul (KR)

(72) Inventors: Garam LEE, SEOUL (KR); Younggi LEE, SEOUL (KR)

(21) Appl. No.: 18/358,315

(22) Filed: Jul. 25, 2023

(30) Foreign Application Priority Data
Jul. 26, 2022 (KR) 10-2022-0092724

(51) Int. Cl. H04L 9/00; H04L 9/06

(52) U.S. Cl. CPC H04L 9/008; H04L 9/0618

(57) ABSTRACT

A method of processing an encrypted message is provided. The method of processing an encrypted message includes dividing text data into sentence units, calculating a vector value of a predetermined size corresponding to each sentence by using a predetermined encoding algorithm for each sentence unit, and generating a homomorphic encrypted message by performing homomorphic encryption on the calculated vector value.

### CROSS-REFERENCE TO RELATED APPLICATION(S)

This application is claiming priority under of a Korean patent application number 10-2022-0092724, filed on Jul. 26, 2022, in the Korean Intellectual Property Office, the disclosure of which is incorporated by reference herein in its entirety.

### BACKGROUND

### Field

Apparatuses and methods consistent with the disclosure relate to an apparatus and method for homomorphic encryption of text data, and more particularly, to an apparatus and method capable of performing homomorphic encryption on text data and storing the text data.

### Description of the Related Art

As communication technology develops and electronic devices spread, efforts are continuously made to maintain communication security between the electronic devices. Accordingly, encryption/decryption technology is used in most communication environments.

When messages encrypted by the encryption technology are delivered to the other party, the other party needs to perform decryption in order to use the messages. In this case, the other party wastes resources and time in the process of decrypting the encrypted data. In addition, when the third party hacks messages while the other party temporarily decrypts the messages for calculation, there is a problem in that the messages may be easily leaked to the third party.

In order to solve this problem, a homomorphic encryption method is being studied. According to the homomorphic encryption, even if calculation is performed on encrypted messages themselves without decrypting the encrypted information, it is possible to obtain the same result as the encrypted value after performing calculation on a plain text. Accordingly, various types of calculations may be performed without decrypting the encrypted messages.

In the past, only numerical data is generated as the homomorphic encrypted message and calculation is performed without being decrypted. However, as a deep learning model is recently developed, processing power for unstructured data such as images, texts, and voices has increased, and privacy protection for the contents of information contained in the unstructured data is required.

### SUMMARY

The disclosure provides an apparatus and method capable of performing homomorphic encryption on text data and storing the text data.

According to an aspect of the disclosure, a method of processing an encrypted message in an arithmetic unit includes dividing text data into sentence units, calculating a vector value of a predetermined size corresponding to each sentence by using a predetermined encoding algorithm for each sentence unit, and generating a homomorphic encrypted message by performing homomorphic encryption on the calculated vector value.

In the generating of the homomorphic encrypted message, homomorphic encryption may be performed on each vector value generated for each sentence unit, and each homomorphic encrypted vector value may be sequentially put into a plurality of slots in the homomorphic encrypted message to generate the homomorphic encrypted message.

In the generating of the homomorphic encrypted message, a sequence index for each of a plurality of sentences in the text data may be generated, the generated sequence index may be encrypted, and the encrypted sequence index and an encrypted vector value corresponding to the sequence index are inserted into a respective slot in the homomorphic encrypted message.

In the generating of the homomorphic encrypted message, the homomorphic encrypted message may be generated by placing the encrypted numerical data in a real number area of the homomorphic encrypted message and placing the encrypted sequence index in an imaginary number area of the homomorphic encrypted message.

The vector value of the predetermined size may be represented as a 32-bit real value within a size of [−1, 1].

The method may further include converting voice data into the text data, in which, in the dividing of the text data into the sentence units, the converted text data may be divided into text units.

The text data may be at least one of a text message and a chat message.

The predetermined encoding algorithm may be a bidirectional encoder representations from transformers (BERT) language model.

According to another aspect of the disclosure, an arithmetic unit includes a memory configured to store text data, and a processor configured to generate a homomorphic encrypted message for the text data, in which the processor divides text data into sentence units, calculates a vector value having a predetermined size for one sentence using a predetermined encoding algorithm for each sentence unit, and performs homomorphic encryption on the calculated vector value to generate the homomorphic encrypted message.

The processor may perform homomorphic encryption on each vector value generated for each sentence unit, and sequentially put each homomorphic encrypted vector value into a plurality of slots in the homomorphic encrypted message to generate the homomorphic encrypted message.

The processor may generate a sequence index for each of a plurality of sentences in the text data, encrypt the generated sequence index, and put the encrypted sequence index and an encrypted vector value corresponding to the sequence index into a respective slot in the homomorphic encrypted message.

The processor may place the encrypted numerical data in a real number area of the homomorphic encrypted message and place the encrypted sequence index in an imaginary number area of the homomorphic encrypted message to generate the homomorphic encrypted message.

When voice data is input, the processor may convert the input voice data into text data and store the text data in the memory.

Therefore, the disclosure is designed to solve the above problems, and since unstructured data is homomorphically encrypted and stored, it is possible to prevent leakage of personal information or the like included in the unstructured data. In addition, since a homomorphic encrypted message that can be calculated is generated, it is possible to apply the homomorphic encrypted message to a deep learning model that processes unstructured data without leakage of personal information.

### BRIEF DESCRIPTION OF THE DRAWINGS

The above and/or other aspects of the disclosure will be more apparent by describing certain embodiments of the disclosure with reference to the accompanying drawings, in which:

FIG. 1 is a diagram for describing a structure of a network system according to one or more embodiments of the disclosure;

FIG. 2 is a block diagram illustrating a configuration of an arithmetic unit according to one or more embodiments of the disclosure;

FIG. 3 is a diagram for explaining a calculation operation for a homomorphic encrypted message;

FIG. 4 is a diagram for describing an operation of converting unstructured data into numerical data according to the disclosure; and

FIG. 5 is a flowchart for describing a method of processing an encrypted message according to one or more embodiments of the disclosure.

### DETAILED DESCRIPTION

Hereinafter, the disclosure will be described in detail with reference to the accompanying drawings. Encryption/decryption may be applied to an information (data) transmission process performed in the disclosure, if necessary, and all expressions describing the information (data) transmission process in the disclosure and claims should be interpreted as including cases of encryption/decryption even if not separately stated. In the disclosure, expressions such as “transmission (delivery) from A to B” or “A receiving from B” include transmission (delivery) or reception with another medium included therebetween, and does not necessarily express only what is directly transmitted (delivered) or received from A to B.

In the description of the disclosure, the order of each step should be understood as non-limiting unless the preceding step needs to be logically and temporally performed necessarily before the following step. In other words, except for the above exceptional cases, even if the process described as the following step is performed before the process described as the preceding step, the nature of the disclosure is not affected, and the scope should also be defined regardless of the order of the steps. In this specification, “A or B” is defined to mean not only selectively indicating either one of A and B, but also including both A and B. In addition, in the disclosure, the term “include” has a meaning encompassing further including other components in addition to elements listed as included.

In this disclosure, only essential components necessary for the description of the disclosure are described, and components unrelated to the essence of the disclosure are not mentioned. In addition, it should not be interpreted as an exclusive meaning that includes only the mentioned components, but should be interpreted as a non-exclusive meaning that may include other components.

In addition, in the disclosure, “value” is defined as a concept including a vector as well as a scalar value. In the disclosure, the expressions such as “compute,” and “calculate” may be replaced by an expression that produces a result of the corresponding computation or calculation. In addition, by processing a homomorphic encrypted message, expressions such as ‘processing’ or ‘changing’ the homomorphic encrypted message may be replaced with an expression of generating a homomorphic encrypted message corresponding to the processing result.

In addition, unless otherwise stated, calculation for an encrypted message to be described below means homomorphic calculation. For example, an addition of a homomorphic encrypted message means a homomorphic addition of two homomorphic encrypted messages.

In the disclosure, text data means data excluding numerical data such as real numbers and imaginary numbers, and includes not only data composed of text but also all types of data (e.g., image data, voice data, etc.) capable of converting specific information into numerical values. Such text data may be referred to as unstructured data, character data.

Mathematical calculation and computations in each step of the disclosure to be described below may be implemented as computer calculations by the known coding method and/or coding designed to suit the disclosure in order to perform the corresponding calculation or computation.

Specific equations to be described below are illustratively described among possible alternatives, and the scope of the disclosure should not be construed as being limited to equations mentioned in the disclosure.

For convenience of description, in the disclosure, a notation is defined as follows.

a←D: select element (a) according to distribution (D)

sk←(1,s(x)),s(x)∈R Each of S1 and S2 is an element belonging to set R

mod(q): Modular calculation with element q

a(x)←R Round-off internal value

Hereinafter, various embodiments of the disclosure will be described in detail with reference to the accompanying drawings.

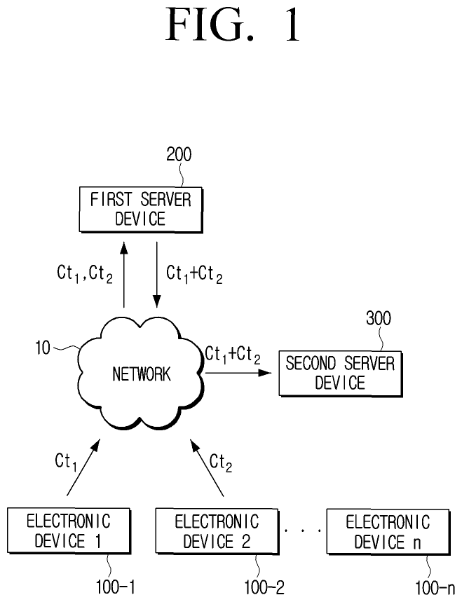

FIG. 1 is a diagram for describing a structure of a network system according to one or more embodiments of the disclosure.

Referring to FIG. 1, a network system may include a plurality of electronic devices 100-1 to 100-n, a first server device 200, and a second server device 300, each of which may be connected to each other through a network 10.

The network 10 may be implemented in various types of wired and wireless communication networks, broadcast communication networks, optical communication networks, cloud networks, etc., and each device may be connected in a manner such as Wi-Fi, Bluetooth, near field communication (NFC), etc. without a separate medium.

Although FIG. 1 illustrates a plurality of electronic devices 100-1 to 100-n, a plurality of electronic devices are not necessarily used, and one device may be used. For example, the electronic devices 100-1 to 100-n may be implemented as various types of devices such as smart phones, tablets, game players, PCs, laptop PCs, home servers, and kiosks. In addition, the electronic devices 100-1 to 100-n may be implemented in the form of home appliances to which an IoT function is applied.

Users may input various types of information through the electronic devices 100-1 to 100-n they use. The input information may be stored in the electronic devices 100-1 to 100-n themselves, but may also be transmitted to and stored in an external device for storage capacity and security reasons. In FIG. 1, the first server device 200 may serve to store such information, and the second server device 300 may serve to use some or all of the information stored in the first server device 200.

Each of the electronic devices 100-1 to 100-n may perform homomorphic encryption on the input information and transmit the homomorphic encrypted messages (or a homomorphic ciphertext) to the first server device 200.

Each of the electronic devices 100-1 to 100-n may include encryption noise, i.e., an error, calculated in the process of performing homomorphic encryption in an encrypted message (or a ciphertext). Specifically, the homomorphic encrypted messages generated by each of the electronic devices 100-1 to 100-n may be generated in a form in which a result value including a message and an error value is restored when decrypted later using a secret key.

For example, when the homomorphic encrypted messages generated by the electronic devices 100-1 to 100-n are decrypted using a secret key, the homomorphic encrypted messages may be generated in a form that satisfies the following natures.

Dec(ct, sk)=<ct, sk>=M+e(mod q) [Equation 1]

Here, <, > denotes a dot product calculation (usual inner product), ct denotes an encrypted message, sk denotes a secret key, M denotes a plain text message, e denotes an encryption error value, and mod q denotes a modulus of an encrypted message. q should be selected to be greater larger than a result value M obtained by multiplying a scaling factor Δ by a message. When an absolute value of the error value e is sufficiently small compared to M, a decryption value M+e of the encrypted message is a value that may replace the original message with the same precision in significant figure calculation. Among the decoded data, an error may be arranged on the least significant bit (LSB) side, and M may be arranged on the next least significant bit side.

When a size of the message is too small or too large, the size may be adjusted using a scaling factor. When the scaling factor is used, not only an integer type message but also a real number type message may be encrypted, and thus, the usability of the message may be greatly increased. In addition, by adjusting the size of the message using the scaling factor, a size of an area where messages exist in the encrypted message after the calculation is made, that is, a size of an effective area may also be adjusted.

Depending on the embodiment, a modulus q of the encrypted message may be set and used in various forms. For example, the modulus of the encrypted message may be set in the form of an exponential power q=Δ^{L} of the scaling factor Δ. When Δ is 2, Δ may be set to a value such as q=2¹⁰.

In addition, the homomorphic encrypted message according to the disclosure will be described on the assumption that unstructured data is homomorphically encrypted. The homomorphic encryption for numerical data is also possible, and calculations between the homomorphic encrypted message for unstructured data and the homomorphic encrypted message for numerical data may be performed in the process described later.

The first server device 200 may store the received homomorphic encrypted message in an encrypted message state without decrypting received homomorphic encrypted message.

The second server device 300 may request a specific processing result for the homomorphic encrypted message from the first server device 200. The first server device 200 may perform specific calculation according to the request of the second server device 300 and then transmit the result to the second server device 300.

For example, when encrypted messages ct1 and ct2 transmitted by the two electronic devices 100-1 and 100-2 are stored in the first server device 200, the second server device 300 may request, from the first server device 200, a value obtained by summing information provided from the two electronic devices 100-1 and 100-2. The first server device 200 may perform calculation for summing the two encrypted messages according to the request, and then transmit the result value ct1+ct2 to the second server device 300. In this case, the server device 200 may perform non-polynomial calculations, statistical calculations, and the like using approximation functions as well as basic calculations such as addition/subtraction.

Due to the nature of the homomorphic encrypted message, the first server device 200 may perform the calculation without the decryption, and the result value is also in the form of an encrypted message. In the disclosure, the result value obtained by calculation is referred to as a calculation result encrypted message. For example, the second server device 200 may perform homomorphic calculation between a first homomorphic encrypted message and a second homomorphic encrypted message by encrypting numerical data.

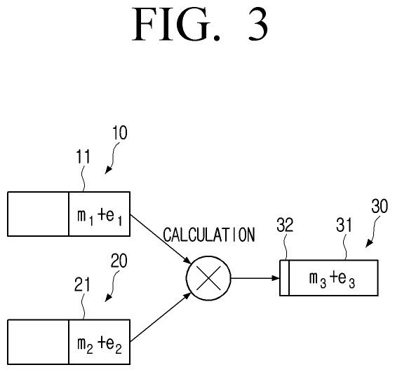

Further, the second server device 200 may perform the homomorphic calculation between the first homomorphic encrypted message in which the numerical data is encrypted and the second homomorphic encrypted message in which the unstructured data (e.g., text data) is encrypted. In addition, the second server device 200 may perform the homomorphic calculation between the first homomorphic encrypted message and the second homomorphic encrypted message in which the unstructured data is encrypted, respectively. This will be described below with reference to FIG. 3.

The first server device 200 may transmit the calculation result encrypted message to the second server device 300. The second server device 300 may decrypt the received calculation result encrypted message and acquire calculation result values of data included in each homomorphic encrypted message.

The first server device 200 may perform the calculation several times according to a user request. In this case, proportions of approximate messages within the calculation result encrypted messages obtained for each calculation are different. The first server device 200 may perform a bootstrapping operation when the proportions of the approximate messages exceed a threshold value. In this way, the first server device 200 may be referred to as an arithmetic unit in that it may perform the calculation operation.

As described above, the network system according to the disclosure may not only perform the homomorphic encryption and homomorphic calculation for general numerical data, but also perform the homomorphic encryption and homomorphic calculation for unstructured data.

Meanwhile, FIG. 1 illustrates a case where the first electronic device and the second electronic device perform the encryption and the second server device performs the decryption, but is not necessarily limited thereto.

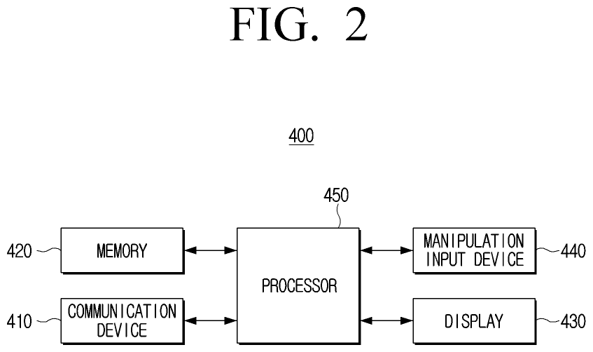

FIG. 2 is a block diagram illustrating a configuration of an arithmetic unit according to one or more embodiments of the disclosure.

Specifically, in the system of FIG. 1, a device that performs homomorphic encryption, such as the first electronic device and the second electronic device, a device that calculates the homomorphic encrypted message, such as the first server device, and a device that decrypts the homomorphic encrypted message, such as a second server device, may be referred to as an arithmetic unit. The arithmetic unit may be various devices such as a personal computer (PC), a laptop computer, a smart phone, a tablet, and a server.

Referring to FIG. 2, an arithmetic unit 400 may include a communication device 410, a memory 420, a display 430, a manipulation input device 440, and a processor 450.

The communication device 410 is formed to connect the arithmetic unit 400 to an external device (not illustrated), and may be connected to the external device through a local area network (LAN) and the Internet network or be connected to the external apparatus through a USB port or a wireless communication (for example, wireless fidelity (WiFi), 802.11a/b/g/n, near field communication (NFC), or Bluetooth) port. Such a communication device 410 may also be referred to as a transceiver.

The communication device 410 may receive a public key from the external device and transmit the public key generated by the arithmetic unit 400 itself to the external device.

Also, the communication device 410 may receive a message from the external device and transmit the generated homomorphic encrypted message to the external device.

Also, the communication device 410 may receive various parameters required for generating an encrypted message from an external device. Meanwhile, upon implementation, various parameters may be directly received from a user through a manipulation input device 440 to be described later.

In addition, the communication device 410 may receive a request for calculation of the homomorphic encrypted message from an external device and transmit the calculated result to the external device.

The memory 420 is a component for storing O/S for driving the arithmetic unit 400, various software, data, and the like. The memory 420 may be implemented in various forms such as RAM, ROM, flash memory, HDD, external memory, and memory card, but is not limited to any one.

The memory 420 stores the message to be encrypted. Here, the message may be text data, voice data, image data, and unstructured data, as well as numerical data such as various credit information and personal information used by a user. In addition, the message may be information related to use history, such as location information used in the arithmetic unit 400 and Internet usage time information.

Here, the image data may be an image (e.g., an image of an ID card, an employee ID card, or a business card) having user's personal information. The text data may be text data having user's personal information (address, resident registration number, and phone number).

In addition, the memory 420 may store a public key, and when the arithmetic unit 400 is a device that directly generates the public key, the memory 420 may store not only a secret key, but also various parameters necessary for generating the public key and the secret key.

Also, the memory 420 may store the homomorphic encrypted message generated in the process described below. Also, the memory 420 may store the homomorphic encrypted message transmitted from the external device. Also, the memory 420 may store the calculation result encrypted message that is the result of the calculation process described later.

The display 430 displays a user interface window for selecting a function supported by the arithmetic unit 400. Specifically, the display 430 may display a user interface window for selecting various functions provided by the arithmetic unit 400. The display 430 may be a monitor such as a liquid crystal display (LCD) and organic light emitting diodes (OLED), and may be implemented as a touch screen capable of simultaneously performing the functions of the manipulation input device 440 to be described later.

The display 430 may display a message requesting input of parameters necessary for generating a secret key and a public key. Also, the display 430 may display a message in which an encryption target selects a message. Meanwhile, in implementation, the encryption target may be directly selected by a user or may be automatically selected. That is, personal information or the like that requires encryption may be automatically set even if a user does not directly select a message.

The manipulation input device 440 may receive a function selection of the arithmetic unit 400 and a control command for the function from the user. Specifically, the manipulation input device 440 may receive parameters necessary for generating a secret key and a public key from the user. Also, the manipulation input device 440 may receive a message to be encrypted from a user.

The processor 450 controls each component in the arithmetic unit 400. The processor 450 may be composed of a single device such as a central processing unit (CPU) and an application-specific integrated circuit (ASIC), or may be composed of a plurality of devices such as a CPU and a graphics processing unit (GPU).

When a message to be transmitted is input, the processor 450 stores the message in the memory 420. The processor 450 uses various setting values and programs stored in the memory 420 to perform homomorphic encryption on the message. In this case, a public key may be used.

The processor 450 may generate and use a public key required to perform encryption by itself, or may receive and use the public key from an external device. For example, the second server device 300 that performs the decryption may distribute a public key to other devices.

When generating a key by itself, the processor 450 may generate a public key using a Ring-LWE technique. Specifically, the processor 450 may first set various parameters and rings and store the parameters and rings in the memory 420. Examples of the parameters may include a length of bits of a plain text message, a size of public and private keys, and the like.

The ring may be represented by the following equation.

R=Z_{q}[x]/(f(x)) [Equation 2]

Here, R denotes a ring, Zq denotes a coefficient, and f(x) denotes an n-th polynomial.

The ring is a set of polynomials having predetermined coefficients, and means a set in which addition and multiplication are defined between elements and which is closed for addition and multiplication. Such a ring may be referred to as an annulus.

For example, the ring means a set of n-th polynomials having a coefficient Zq. Specifically, when n is Φ(N), it means an N-th cyclotomic polynomial. f(x) denotes ideal of Zq[x] generated by the f(x). The Euler totient function Φ(N) means the number of natural numbers that is coprime to N and smaller than N. When Φ_{N}(x) is defined as an N-th cyclotomic polynomial, the ring may also be represented by Equation 3 as follows.

R=Z_{q}[x]/Φ_{N}(x)) [Equation 3]

A secret key sk may be represented as follows.

Meanwhile, the ring of Equation 3 described above has a complex number in the plain text space. Meanwhile, in order to improve the calculation speed of the homomorphic encrypted message, only a set in which the plain text space is a real number in the above-described set of rings may be used. Alternatively, as described later, in the case of the unstructured data, the encryption data corresponding to the unstructured data has values in the real number, and the information (e.g., index information related to order (e.g., word order, sentence order, voice order, etc.), index information related to location, attribute information for attributes of unstructured data) related to the unstructured data may have values in an imaginary number.

When such a ring is established, the processor 450 may calculate the secret key sk from the ring.

SK←(1,s(x)),s(x)∈R [Equation 4]

Here, s(x) means a polynomial generated randomly with small coefficients.

The processor 450 calculates a first random polynomial a(x) from the ring. The first random polynomial may be represented as follows.

a(x)←R [Equation 5]

Also, the processor 450 may calculate an error. Specifically, the processor 450 may extract an error from a discrete Gaussian distribution or a distribution statistically close to the discrete Gaussian distribution. This error may be represented as follows.

e(x)←Dₐⁿ [Equation 7]

When an error is calculated, the processor 450 may calculate a second random polynomial by modularly calculating an error in the first random polynomial and the secret key. The second random polynomial may be represented as follows.

b(c)=−a(x)s(x)+e(x)(mod q) [Equation 7]

Finally, a public key pk is set as follows in a form including the first random polynomial and the second random polynomial.

pk=(b(x), a(x) [Equation 8]

Since the above-described key generation method is only an example, it is not necessarily limited thereto, and it goes without saying that the public key and the private key may be generated by other methods.

Meanwhile, when a public key is generated, the processor 450 may control the communication device 410 to transmit the public key to other devices.

The processor 450 may generate a homomorphic encrypted message for a message. Specifically, the processor 450 may generate a homomorphic encrypted message by applying the previously generated public key to the message. In this case, the processor 450 may generate the length of the encrypted message to correspond to the size of the scaling factor.

Also, the processor 450 may check attributes of data to be subjected to the homomorphic encryption. The processor 450 may perform preprocessing according to the checked data attributes or perform the homomorphic encryption in a corresponding manner.

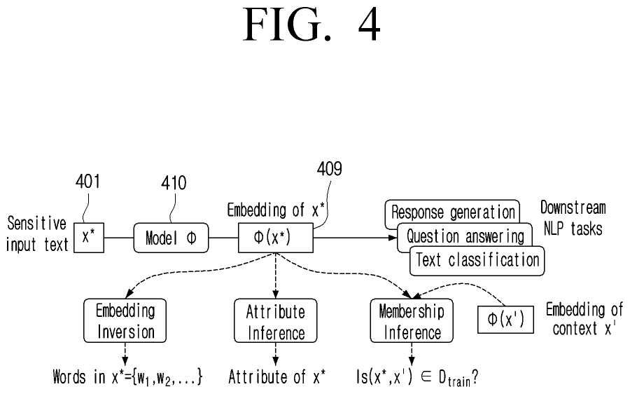

For example, when the encryption target is the text data, the processor 450 may perform processing to remove unnecessary symbols (e.g., marks, special characters), etc., from the text data, and may calculate vector values for each sentence by using a predetermined encoding algorithm for each sentence. In this case, the processor 450 may calculate the vector values for each sentence by using a bidirectional encoder representations from transformers (BERT) language model. The BERT language model and the vector value calculation operation using the BERT language model will be described later with reference to FIG. 4.

Further, the processor 450 may generate the homomorphic encrypted message by performing homomorphic encryption on the calculated vector value. Specifically, the homomorphic encrypted message may be generated by performing the homomorphic encryption on each vector value generated for each sentence unit and putting the homomorphic encrypted vector values into a plurality of slots in the homomorphic encrypted message. In this case, the processor 450 may sequentially put homomorphic encrypted vector values into a plurality of slots corresponding to the sentence order.

Alternatively, the processor 450 may generate sequence indexes for each of the plurality of sentences, and put each vector value corresponding to the generated sequence index into one slot. Specifically, the homomorphic encrypted message includes a real number area and an imaginary number area, and the processor 450 may put the above-described encrypted vector value into the real number area in the homomorphic encrypted message and put a sequence index into the imaginary number area. In addition, conversely, it is also possible to put an encrypted vector value into the imaginary number area and put a sequence index into the real number area. In this case, the sequence index may be stored in a plain text state, or may be stored in an encrypted state after being homomorphically encrypted.

Meanwhile, in the foregoing, it has been described that the text data is divided into sentence units, and the vectorization for each sentence unit, and the homomorphic encryption are performed, but in implementation, it is also possible to perform the homomorphic encryption in word units. For example, it is also possible to classify the text sentence into word units and perform homomorphic encryption on index values corresponding to each word. As the index value used here, an index table directly defined by a user may be used, and a location (or order) of the corresponding word in a specific dictionary may be used.

In addition, in the case of the text data used for chatting services and SNS services, it is also possible to divide texts in chatting order (or channel order for each user) and SNS display order (time order), and to perform the homomorphic encrypted messages in divided text units.

When the encryption target is voice data, the processor 450 may perform the homomorphic encryption by one of the following two methods. A first method is a method of homomorphic encryption of voice data itself. Specifically, the method is a method of homomorphic encryption of digitized signal values for each frequency band of voice data. In other words, it is a method of performing homomorphic encryption by considering a signal value itself constituting voice data as a numerical value.

In this case, the processor 450 may divide voice data into predetermined time units, perform homomorphic encryption on the voice data for each time unit, and put the encrypted data in several time units into a plurality of slots in the homomorphic encrypted message to generate a homomorphic encrypted message. Specifically, the homomorphic encrypted message may be generated by performing the homomorphic encryption on the voice data in the predetermined time units and putting the homomorphic encrypted voice data into the plurality of slots. In this case, the processor 450 may sequentially put the homomorphic encrypted voice data into the plurality of slots corresponding to the time order.

Alternatively, the processor 450 may generate sequence indexes for each voice data, and put the encrypted voice data corresponding to the generated sequence index into one slot. Specifically, the processor 450 may put the above-described encrypted voice data into the real number area of the homomorphic encrypted message and put the sequence index into the imaginary number area. In this case, the sequence index may be stored in a plain text state, or may be stored in an encrypted state after being homomorphically encrypted. Also, the encrypted voice data may be stored in the imaginary number area, and the sequence index may be stored in the real number area.

A second method performs homomorphic encryption on content of voice data. The processor 450 may generate text data by performing voice recognition on the voice data, and perform homomorphic encryption on the generated text data. The method of performing homomorphic encryption on text data may perform the homomorphic encryption as described above.

When the encryption target is an image, the processor 450 may perform the homomorphic encryption in one of the following two methods. A first method performs homomorphic encryption on image data itself, and is a method of homomorphic encryption of each data for each channel (e.g., R/G/B, CMYK, etc.) constituting an image.

In this case, the processor 450 may divide the corresponding image into a plurality of areas according to the size of the image and perform the homomorphic encryption on data for each divided area. For example, when one image is divided into 9 blocks, the homomorphic encryption may be performed on each block, and each block may be stored in each slot of the homomorphic encrypted message. In this case, the processor 450 may store the encrypted image blocks in the slot order corresponding to the block order. Alternatively, the processor 450 may assign an index to each block and store the assigned index and the encrypted block image corresponding to the corresponding index in one slot. For example, the encrypted block image may be stored in the real number area of the encrypted message, and the block index may be stored in the imaginary number area.

A second method performs homomorphic encryption on text (information) in image data, and the processor 450 may perform OCR on image data and perform homomorphic encryption on the text data coming from the OCR result.

Meanwhile, the image may have various forms. For example, in the case of photos, the homomorphic encryption may be performed in the first method as described above. In addition, the homomorphic encryption may be performed on an image, such as a document in which only text exists, by the second method. In addition, in the case of the image in which the photo (or graphic) and text are mixed, the homomorphic encryption is performed on an area corresponding to the photo by the first method described above, the OCR is performed on the text area by the second method described above, and the homomorphic encryption may be performed on the text corresponding to the OCR result.

In this case, the processor 450 may separately encrypt information on the layout of the text, photo, etc., included in the image, so the same type of image may be reconstructed later in a restoration process. For example, the processor 450 may store encrypted data of an area (i.e., arrangement location) on image of data and attribute information corresponding to the area stored in each slot.

For example, when image A and text B are arranged in one image, the processor 450 may perform encryption in a manner corresponding to each content attribute as described above, put the encrypted image A in a real number area of a first slot and attribute information that the image A is an image and information on an arrangement location in an imaginary number area or the the first slot, and put a homomorphic encryption result of a vector value (or ASCII value constituting the corresponding text) of the text B in a real number area of s second slot and put information that the text B is text and information on an arrangement location into an imaginary number area of the second slot. For example, although one content has been described as being placed in one slot in a homomorphic encrypted message, one content may occupy a plurality of slots in implementation. This is, for example, encrypted data for block A of an image placed in the first slot of a homomorphic encrypted message, encrypted data for block B of the image placed in the second slot of the homomorphic encrypted message, etc.

As such, various types of encryption are possible for the image. The processor 450 may select an encryption method from a user before performing the homomorphic encryption on the image and perform the encryption method, or determine the encryption method in advance through image analysis, and perform processing corresponding to the determined method.

In the above, the homomorphic encryption method for three types of unstructured data such as text data, voice data, and image data has been described, but it is possible to perform homomorphic encryption on various unstructured data other than the above examples.

When the homomorphic encrypted message is generated, the processor 450 may control the communication device 410 to store the homomorphic encrypted message in the memory 420 or transmit the homomorphic encrypted message to another device according to a user request or a preset default command.

Meanwhile, according to one or more embodiments of the disclosure, packing may be performed. When the packing is used in the homomorphic encryption, it becomes possible to encrypt a plurality of messages into one encrypted message. In this case, one encrypted message may be expressed as having a plurality of slots, and the encrypted message for one unstructured data may be stored in each slot described above. For example, when generating a homomorphic encrypted message for text data composed of a plurality of sentences, vector values corresponding to each sentence may be calculated, and the homomorphic encrypted data for the calculated vector values may be put into each slot to generate the homomorphic encrypted message. In this case, when the arithmetic unit 400 performs calculations between each encrypted message, since calculations for multiple messages are processed in parallel, the calculation burden is greatly reduced.

Specifically, when a message is composed of a plurality of message vectors, the processor 450 may transform a plurality of message vectors into a polynomial in a form that the plurality of message vectors may be encrypted in parallel, multiply the polynomial by a scaling factor, and perform the homomorphic encryption using a public key. Accordingly, an encrypted message in which a plurality of message vectors are packed may be generated.

Further, when the homomorphic encrypted message needs to be decrypted, the processor 450 may apply a secret key to the homomorphic encrypted message to generate a polynomial-type decrypted message, and decode the polynomial-type decrypted message to generate a message. In this case, the generated message may include an error as mentioned in Equation 1 described above.

The processor 450 may perform calculation on the encrypted message. Specifically, the processor 450 may perform calculations such as addition or multiplication on a homomorphic encrypted message while maintaining an encrypted state. Also, the processor 450 may perform various statistical calculations as well as the four arithmetic operations as described above.

Meanwhile, when calculation is completed, the arithmetic unit 400 may detect data in an effective area from calculation result data. Specifically, the arithmetic unit 400 may detect the data in the effective area by performing rounding processing on the calculation result data. The rounding processing means rounding-off a message in an encrypted state, and may also be referred to as rescaling. Specifically, the arithmetic unit 400 removes a noise region by multiplying each component of the encrypted message by Δ⁻ which is the reciprocal of the scaling factor, and rounding-off each component of the encrypted message. The noise area may be determined to correspond to the size of the scaling factor. As a result, it is possible to detect a message in the effective area from which the noise area is excluded. Since it proceeds in an encrypted state, an additional error occurs, but the size is small enough to be ignored.

As described above, the arithmetic unit 400 according to one or more embodiments of the disclosure may not only perform the homomorphic encryption and homomorphic calculation for general numerical data, but also perform the homomorphic encryption and homomorphic calculation for unstructured data.

FIG. 3 is a diagram for describing a calculation operation for a homomorphic encrypted message. Specifically, FIG. 3 illustrates calculation of two homomorphic encrypted messages 10 and 20.

Each homomorphic encrypted message 10 and 20 may include approximate message areas 11 and 21, respectively. The approximate message areas 11 and 21 include messages and errors m1+e1 and m2+e2 together.

For example, when two homomorphic encrypted messages encrypt numerical data, the homomorphic calculation result (Enc(m₃)=Enc(m₁)+Enc(m₂)) of the two homomorphic encrypted messages is the same as that of the homomorphic encryption of the calculation result (Enc(m₁)+m₂)) on the plain text.

The following describes the method of calculating unstructured data, not general numerical data.

As an example, it is assumed that a distribution of a residential area of people with the name “AAA” is statistically analyzed. It is possible to digitize and store the residential area as a specific value corresponding to the residential area, such as Seoul 1 and Busan 2, but it is difficult to digitize and store the name. Therefore, it is assumed that the name is stored as text itself, and the residential area is stored as a numerical value corresponding to the corresponding area.

In this case, the first data 100 may store encrypted names of a plurality of users and an index value of a residential area that are homomorphically encrypted. In this case, in order to find how much data has a first name and a first residential area, a mask encrypted message 20 having an index for the encrypted first name and the encrypted first residential area in a plurality of slots may be used.

In addition, an approximate comparison between the two homomorphic encrypted messages may be performed to generate an encrypted message 30 having only information on the number of users having a specific name AAA and a specific area 1. Here, the approximate comparison may be a comparison in which an encrypted value of 1 is calculated for results having the same value and an encrypted value of 0 is calculated for results having different values. Therefore, the resulting homomorphic encrypted message 30 may only have the encrypted values of 1 and 0. If necessary, it is possible to obtain other necessary information by performing various other homomorphic calculations using the corresponding data. In addition, since the resulting homomorphic encrypted message does not include user information or the like and indicates only that data corresponding to the information corresponding to a filter exists, there is no room for personal information to be leaked. In addition, since the resulting data itself is also in the state of the homomorphic encrypted message, even if the resulting data is leaked, a secret key for the encrypted message is not known and thus the result is not known, so the security in the process of processing personal information is high.

As another example, the case in which image data is used as the unstructured data will be described. Recently, by using personal identification, there are cases in which an identification card is photographed and submitted to an institution or the like. However, since the identification card contains various types of personal information, great damage may occur when a photographed image is exposed.

However, when the ID image is stored with homomorphic encryption according to the disclosure, it is impossible to check personal information without a secret key even if the corresponding data is exposed.

Meanwhile, when the image submitted to the institution is the homomorphic encrypted message, the institution may not check whether the encrypted message is a legitimate image. In order to check this, the homomorphic encrypted message may be decrypted and processed. However, when the method of the disclosure is used, it is possible to verify whether the homomorphic encrypted message submitted without decryption is an image for a legitimate identification card.

For example, in the case of the ID card, the institution that issued the ID card and the image of the institution are included. Therefore, in the case of the homomorphic encryption of the ID image in the above method, an area corresponding to a photo, text information on an institution issuing ID, and an image of the corresponding institution may each be encrypted according to each attribute and stored in each slot of the homomorphic encrypted message.

Therefore, the institution that performs the verification of the ID card may generate text (the institution that issued the ID card) corresponding to a type of submitted ID card and/or the homomorphic encrypted message for each image of the corresponding institution (generating the second homomorphic encrypted message as described above), and perform an approximate comparison operation between the submitted first homomorphic encrypted message and second homomorphic encrypted message. As the calculation result, the encrypted message may generate a calculation result encrypted message 300 having an encrypted value of 1 when at least one of the text corresponding to the institution and the institution image is included in the first homomorphic encrypted message.

In this case, by decrypting the encrypted message as the calculation result and checking whether a value of 1 is included, it is checked whether a legitimate ID is submitted or by putting a filter value into the result during another homomorphic calculation process, normal results may be obtained only when there is a legitimate ID result.

Meanwhile, the calculation operation as described above is not limited to one example, and the above-described object may be achieved in a method other than the above-described example by combining various homomorphic calculation methods. In addition, since the unstructured data may be used in various fields, it may be applied to the case where personal information protection is required other than the above examples.

FIG. 4 is a diagram for describing an operation of converting unstructured data into numerical data according to the disclosure. Referring to FIG. 4, a BERT language model for converting text data into numerical data is illustrated.

The BERT model is a model that embeds received text data and converts the received text data into numerical data. This model converts one text sentence into a vector having a length of 768 or an array of the number of tokens of 768x. Here, numerical data generated may be a 32-bit real number in floating point format between [−1, 1]. This model checks a word index (numerical value) corresponding to each of a plurality of words constituting one sentence, takes the plurality of corresponding word index values as input values of the corresponding model, and calculates the vector value as described above as a result thereof.

In this way, although the BERT calculates a vector value composed only of numbers, it may recover the original text based on the vector value. Reflecting this point, in the disclosure, text data is divided into sentences, and the vector value described above is encrypted for each divided sentence to perform the homomorphic encryption on the text data.

Meanwhile, although it has been described above that homomorphic encryption is performed in string units, it is also possible to perform the homomorphic encryption in units of word indexes that are the input of the BERT model.

For example, when the sentence “I like korea” is homomorphically encrypted, the output vector value of the BERT model for “I like korea” can be homomorphically encrypted. Alternatively, it is also possible to perform homomorphic encryption on a word index value corresponding to “I”, a word index value corresponding to “like”, and a word index value corresponding to “korea.”

In this way, when the text is homomorphic encrypted in sentence units, it is possible to use the corresponding homomorphic encrypted message as follows.

A deep learning model that analyzes emotion in text using a plurality of texts is being developed. In order to learn or use the deep learning model, various text data are required, and such text data may include personal information such as name, address, and personal privacy information. Therefore, when text data is used without encryption, personal information exposure may occur. However, when the text data is homomorphically encrypted according to the disclosure and the homomorphic encrypted message is used as learning data, it is possible to train various deep learning models without exposing personal information.

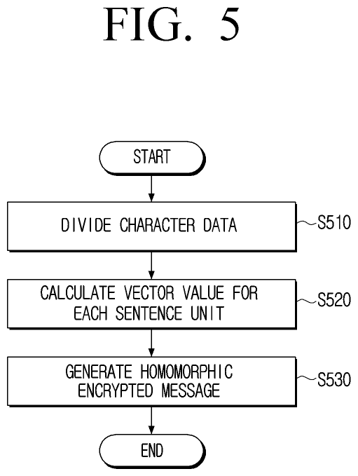

FIG. 5 is a flowchart for describing a method of processing an encrypted message according to one or more embodiments of the disclosure.

Referring to FIG. 5, first, text data is divided into sentence units (S510). Meanwhile, when data to be encrypted is voice data, the voice data may be converted into text data using a voice recognition model in advance.

Then, a vector value having a predetermined size for one sentence is calculated using a predetermined encoding algorithm for each sentence unit (S520). Here, the vector value of the predetermined size may have a real value of 32 bits within the size of [−1, 1], and the predetermined encoding algorithm may be the BERT language model.

Then, the calculated vector value is homomorphically encrypted to generate the homomorphic encrypted message (S530). Specifically, the homomorphic encrypted message may be generated by performing the homomorphic encryption on each vector value generated for each sentence unit and sequentially putting each of the homomorphic encrypted vector values into a plurality of slots in the homomorphic encrypted message.

Alternatively, by generating the sequence index for each of the plurality of sentences in the text data, encrypting the generated sequence index, and putting the encrypted sequence index for each of the plurality of sentences and the encrypted vector value corresponding to the encrypted sequence index into one of a plurality of slots in the homomorphic encrypted message, the homomorphic encrypted message may be generated. In this case, by placing the encrypted numerical data in the real number area of the homomorphic encrypted message and placing the encrypted sequence index in the imaginary number area of the homomorphic encrypted message, the homomorphic encrypted message may be generated.

As such, the method of processing an encrypted message according to the disclosure can generate the homomorphic encrypted message not only for numerical data but also for various unstructured data such as text data, image data, and voice data.

Meanwhile, the above-described encrypted message processing method according to various embodiments may be implemented in the form of program code for performing each step, and stored and distributed in a recording medium. In this case, the device equipped with the recording medium may perform operations such as the above-described encryption or encrypted message processing.

Such a recording medium may be various types of computer readable media such as ROM, RAM, memory chip, memory card, external hard, hard, CD, DVD, magnetic disk, or magnetic tape.

Although the disclosure has been described with reference to the accompanying drawings, the scope of the disclosure is determined by the claims to be described below and should not be construed as being limited to the foregoing embodiments and/or drawings. In addition, it should be clearly understood that improvements, changes and modifications obvious to those skilled in the art of the disclosure described in the claims are also included in the scope of the disclosure.

What is claimed is:

1. A method of processing an encrypted message in an arithmetic unit, the method comprising:
dividing text data into sentence units;
calculating a vector value of a predetermined size corresponding to each sentence by using a predetermined encoding algorithm for each sentence unit; and
generating a homomorphic encrypted message by performing homomorphic encryption on the calculated vector value.

2. The method as claimed in claim 1, wherein, in the generating of the homomorphic encrypted message, homomorphic encryption is performed on each vector value generated for each sentence unit, and each homomorphic encrypted vector value is sequentially put into a plurality of slots in the homomorphic encrypted message to generate the homomorphic encrypted message.

3. The method of claim 1, wherein, in the generating of the homomorphic encrypted message, a sequence index for each of a plurality of sentences in the text data is generated, the generated sequence index is encrypted, and the encrypted sequence index and an encrypted vector value corresponding to the sequence index are inserted into a respective slot in the homomorphic encrypted message.

4. The method as claimed in claim 3, wherein, in the generating of the homomorphic encrypted message, the homomorphic encrypted message is generated by placing the encrypted numerical data in a real number area of the homomorphic encrypted message and placing the encrypted sequence index in an imaginary number area of the homomorphic encrypted message.

5. The method as claimed in claim 1, wherein the vector value of the predetermined size is represented as a 32-bit real value within a size of [−1, 1].

6. The method as claimed in claim 1, further comprising:
converting voice data into the text data,
wherein, in the dividing of the text data into the sentence units, the converted text data is divided into text units.

7. The method as claimed in claim 1, wherein the text data is at least one of a text message and a chat message.

8. The method as claimed in claim 4, wherein the predetermined encoding algorithm is a bidirectional encoder representations from transformers (BERT) language model.

9. An arithmetic unit, comprising:
a memory configured to store text data; and
a processor configured to generate a homomorphic encrypted message for the text data,
wherein the processor divides text data into sentence units, calculates a vector value having a predetermined size for one sentence using a predetermined encoding algorithm for each sentence unit, and performs homomorphic encryption on the calculated vector value to generate the homomorphic encrypted message.

10. The arithmetic unit as claimed in claim 9, wherein the processor performs homomorphic encryption on each vector value generated for each sentence unit, and sequentially puts each homomorphic encrypted vector value into a plurality of slots in the homomorphic encrypted message to generate the homomorphic encrypted message.

11. The arithmetic unit as claimed in claim 9, wherein the processor generates a sequence index for each of a plurality of sentences in the text data, encrypts the generated sequence index, and puts the encrypted sequence index and an encrypted vector value corresponding to the sequence index into a respective slot in the homomorphic encrypted message.

12. The arithmetic unit as claimed in claim 11, wherein the processor places the encrypted numerical data in a real number area of the homomorphic encrypted message and places the encrypted sequence index in an imaginary number area of the homomorphic encrypted message to generate the homomorphic encrypted message.

13. The arithmetic unit as claimed in claim 9, wherein, when voice data is input, the processor converts the input voice data into text data and stores the text data in the memory.

14. A non-transitory computer-readable recording medium which includes a program for executing a method for processing an encrypted message, wherein the method includes:
dividing text data into sentence units;
calculating a vector value of a predetermined size corresponding to each sentence by using a predetermined encoding algorithm for each sentence unit; and
generating a homomorphic encrypted message by performing homomorphic encryption on the calculated vector value.
